(19) United States
(12) Patent Application Publication
(10) Pub. No.: US 2014/0125479 A1
(43) Pub. Date: May 8, 2014

(54) CAREGIVER ALERT SYSTEM

(71) Applicant: Shelley Jane Schmidt, Granada Hills, CA (US)

(72) Inventor: Shelley Jane Schmidt, Granada Hills, CA (US)

(21) Appl. No.: 13/854,807

(22) Filed: Apr. 1, 2013

Related U.S. Application Data
(60) Provisional application No. 61/619,252, filed on Apr. 2, 2012.

(51) Int. Cl. G08B 25/01

(52) U.S. Cl. CPC G08B 25/016
USPC 340/539.11

(57) ABSTRACT

Described is a caregiver alert that allows a caregiver to remotely monitor the condition and needs of a patient. The system includes a patient device that is adapted to receive a command from a patient and transmit an alert signal wirelessly. Additionally, the system includes a caregiver device adapted to receive the alert signal and generate an alert indicator to notify a caregiver that the patient is in need of assistance. Each of the patient device and caregiver device are formed as wristbands (or any other suitably convenient item) to be worn by a user.

### CROSS-REFERENCE TO RELATED APPLICATIONS

The present application is a Non-Provisional Utility Patent Application of U.S. Provisional Application No. 61/619,252, filed on Apr. 2, 2012, entitled, “The Care Giver Alert System.”

### BACKGROUND OF THE INVENTION

(1) Field of Invention

The present invention relates to a monitoring system and, more particularly, to a monitoring system that allows a caregiver to remotely monitor the condition and needs of a patient.

(2) Description of Related Art

Monitoring systems have long been known in the art. Traditional monitoring systems are provided through the use of an external agency, such as Life Alert (located at 475 Park Avenue South, 9th Floor, New York, N.Y. 10016). The Life Alert system is a medical alert system that is designed to allow seniors to signal the company when they are in need of assistance. For example, the typical Life Alert device is a pendant that is worn around the neck of a user. If the user needs assistance, the user presses a button on the pendant which sends a signal, through a phone line, to the remote company. The company can then call back the user to verify their status and, if needed, send emergency help. While operable to monitor the patient or user remotely, the traditional Life Alert system does not allow a caregiver in the home the ability to remotely monitor the needs of the patient.

Other systems that are available require a monthly payment, which can be prohibitively expensive for some individuals.

Thus, a continuing need exists for an affordable and improved caregiver alert system that allows a caregiver to remotely monitor the needs of a patient.

### SUMMARY OF INVENTION

The present invention is a caregiver alert that allows a caregiver to remotely monitor the condition and needs of a patient. The system includes a patient device that is adapted to receive a command from a patient and transmit an alert signal wirelessly. Additionally, the system includes a caregiver device adapted to receive the alert signal and generate an alert indicator to notify a caregiver that the patient is in need of assistance. Each of the patient device and caregiver device are formed as wristbands (or any other suitably convenient item) to be worn by a user.

In another aspect, each of the patient device and caregiver device further comprise a microphone and audio output device, whereby a patient and a caregiver can communicate with one another wirelessly through speaking into the microphone and receiving an audible response from the corresponding audio output device.

In yet another aspect, the caregiver alert system includes a plurality of patient devices, each adapted to generate a unique alert signal. In this aspect, the caregiver device is adapted to recognize which patient device is generating the alert signal.

Further, the caregiver device is programmable to associate at least one of a name and room number with a particular alert signal, such that upon receiving an alert signal, the alert indicator indicates which patient device generated the alert signal.

In another aspect, the caregiver device further comprises a display for displaying at least one of a name and room number that is associated with the alert signal.

Finally, as can be appreciated by one in the art, the present invention also comprises a method for forming and using the invention described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is an illustration of a caregiver alert system according to the principles of the present invention; and

FIG. 2 is an illustration of a caregiver alert system according to the principles of the present invention.

### DETAILED DESCRIPTION

The present invention relates to a monitoring system and, more particularly, to a monitoring system that allows a caregiver to remotely monitor the condition and needs of a patient. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

### (1) Description

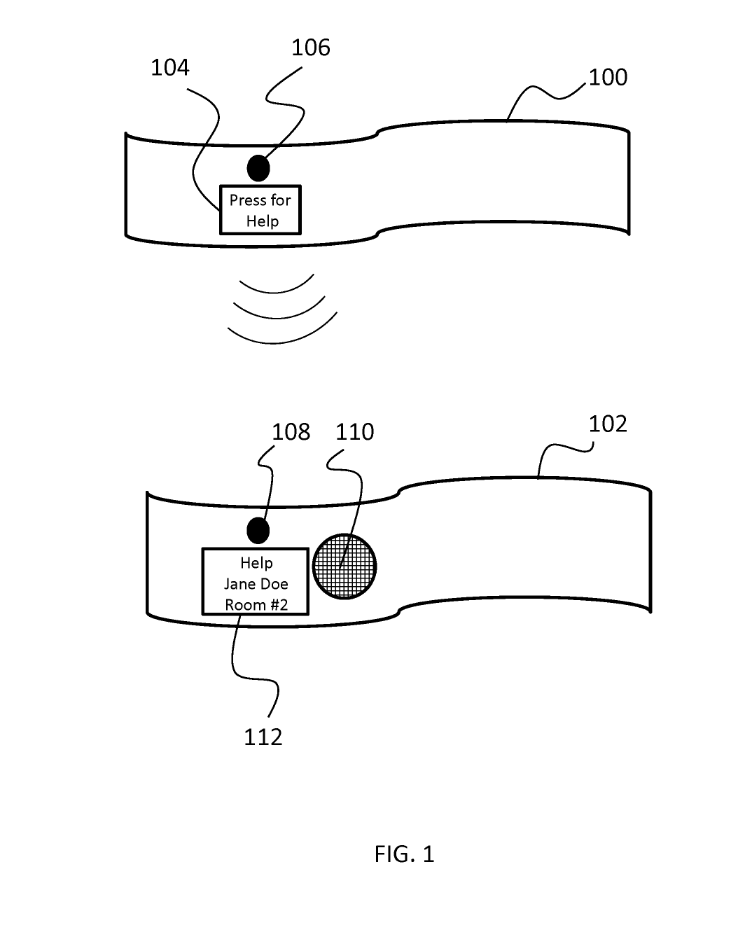

As noted above, the present invention is directed to a monitoring system that allows a caregiver, in a patient's home, to remotely monitor the condition and needs of a patient. As shown in FIG. 1, the monitoring system includes a set of monitoring devices that allow at least one of the devices to communicate with the other. In another aspect, both devices (or multiple devices) can communicate with each other (or any combination thereof). The monitoring devices are any suitable mechanism or device that allows for quick access and wireless communicative capabilities, non-limiting examples of which include bracelets, wristband, watches, pendants, etc., that each include the relevant components to provide for the functionality described herein. As another non-limiting example, the monitoring devices are wristbands that can be attached with a user's wrist via hook and loop fasteners (e.g., Velcro), can be attached as a bendable wire or, in another aspect, can be formed as a snap band that includes the components herein.

For example and as show in FIG. 1, the monitoring devices include a patient device 100 and a caregiver device 102. In one aspect, the patient device 100 is a wristband that includes a button 104 (or any other suitable mechanism or device) that allows a patient to depress the button 104 to indicate a need for assistance (i.e., send an alert signal). In other words, the patient device 100 is adapted to receive a command from a user (such as through depression of the button 104). The patient device can also include a light 106 or other indicia that indicates when the button 104 has been activated or depressed. For example, the light 106 can illuminate in a desired color (e.g., green) when the button is pressed. Once the button 104 is depressed, the patient device 100 generates and transmits (via a transmitter) an alert signal wirelessly (via Radio Frequency, Bluetooth, or any other suitable transmission technique) that is to be received by the caregiver device 102.

Alternatively, the caregiver device 102 receives the alert signal (via a receiver) and generates an alert indicator to notify the caregiver that the patient is in need of assistance. The alert indicator is any suitable mechanism, device, or technique that can be utilized to indicate the need of a user. As non-limiting examples, the alert indicator is a light 108 (such as a red light) or an audio output device 110 (such as a speaker and applicable circuitry), or any combination thereof.

As another non-limiting example, the alert indicator can include a display 112 (e.g., an LCD display or any other suitable display) that can be used to provide a message to the caregiver. For example, in some aspects, a caregiver may be helping multiple patients. In this aspect, the caregiver device can be programmed to list and display the actual name and room number of the patient that is sending the alert signal. In this aspect, the monitoring system includes several patient devices 100 (e.g., one for each patient). Each patient device 100 can be programmed with a name, etc. of the patient or can simply be allocated its own unique alert signal. Thus, when the relevant alert signal is received by the caregiver device 102, the caregiver device 102 recognizes the alert signal as being designated by a particular patient and provides indicia indicating the particular patient device 100 that generated the alert signal. For example, the caregiver device 102 can have multiple lights, each of which is indicative of a particular patient device 100. Alternatively, the caregiver device 102 can be programmed with names and room numbers associated with each alert signal such that when a particular alert signal is received, the name and room number of the particular patient associated with a particular patient device 100 is provided on the display 112.

The caregiver device 112 and any patient device 100 (if applicable) can be programmed using any suitable mechanism or device that allows for programming. As a non-limiting example, the caregiver device 112 (and/or patient device 100) can include a micro-USB port that allows the device to be plugged into a computer for programming. As can be appreciated by one skilled in the art, on each of the caregiver device 112 and patient device 100 is all of the relevant circuitry (e.g., any suitable microprocessor/integrated circuit), power supply (e.g., battery), components, and receivers and transmitters (or transceivers) that are required to provide the functions described herein. A non-limiting example of a suitable transmitter is the Miniature AM RF Transmitter Module: AT-MT1 by ABACOM Technologies Inc., located at 3210 Wharton Way, MISSISSAUGA ON L4X 2C1, CANADA. Alternatively, a non-limiting example of a suitable transceiver is the 433 Mhz Mini RF Transceiver Module FC-RF1023 20 dBm(max) with SPI, by Shenzhen Friendcom Technology Development Co., Ltd., in Guandong, China. Thus, as can be appreciated by one skilled in the art, any suitable circuitry and/or components (e.g., receivers, transmitters, transceivers, displays, circuits, buttons, etc.) as may be necessary can be employed and connected with one another to provide the functionality described herein.

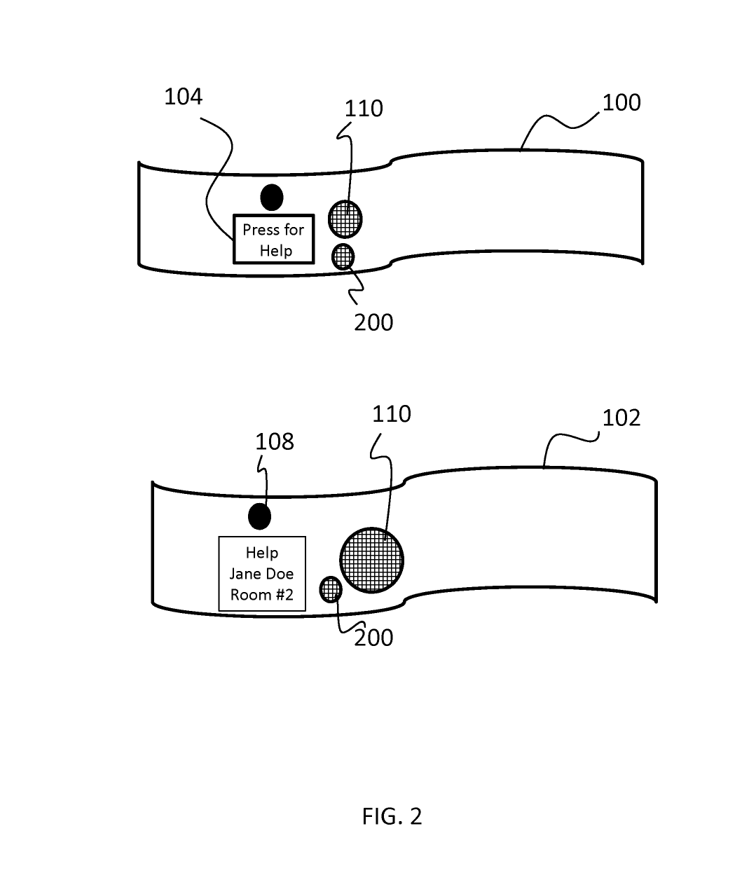

In another aspect and as depicted in FIG. 2, the patient device 100 and caregiver device 102 can both include an audio output device 110. Thus, in operation, the patient device 100 can be activated to send an alert signal which is received by the caregiver device 102. In addition to any light 108 or other indicia, a beep or alert sound can be generated by the microprocessor and audibilized using the audio output device 110. A microphone 200 (or any other suitable audio receiving device) can be included on one or both of the patient device 100 and caregiver device 102. The microphone 200 is connected with the relevant circuitry in each device 100 and 102 to allow for receipt and transmission of an audio signal.

Thus, once receiving an alert signal and being alerted by the caregiver device 102, the caregiver can speak into the microphone 200 and transmit (wirelessly) a signal that is received by the patient device 100, which is then audibilized and output to the patient via the audio output device 110 on the patient device 100. The caregiver and patient can then communicate with one another remotely via the microphone 200 and audio output device 110 on each of their respective monitoring system devices 100 and 102.

As can be appreciated by one skilled in the art, each of the patient device 100 and caregiver device 102 can be made in a variety of shapes, sizes, colors, etc. Further, they can be formed such that the electrical components are sealed to provide for water resistant or waterproof features.

In another aspect, either one or both of the patient device 100 and/or caregiver device 102 can be configured to include bluetooth or other wireless communicative capabilities to allow the device(s) to interact with a mobile device (e.g., cell phone or tablet computer (e.g., iPad)). Thus, in this aspect, the alert system is operable for providing alert signals (and other communicative signals (e.g., voice, etc.) that can be received by a cell phone or other device. As a non-limiting example, the patient device 100 can send an alert signal to a caregiver device 102. The caregiver device 102 can send a Bluetooth signal that is received by the caregiver's celphone and which causes the celphone to ring or otherwise provide an additional signal (audio or otherwise (e.g., vibration) to alert the caregiver.

It should be understood that the specific examples provided herein are non-limiting examples according to the principles of the present invention and that other embodiments and/or aspects are conceived by the present invention. Thus, as can be appreciated, the present invention is not intended to be limited to the embodiments presented, but is to be accorded the widest scope consistent with the principles and novel features disclosed herein.

What is claimed is:

1. A caregiver alert system, comprising:
a patient device, the patient device adapted to receive a command from a patient and transmit an alert signal wirelessly; and
a caregiver device, the caregiver device adapted to receive the alert signal and generate an alert indicator to notify a caregiver that the patient is in need of assistance.

2. The caregiver alert system as set forth in claim 1, wherein each of the patient device and caregiver device are formed as wristbands to be worn around the wrist of a user.

3. The caregiver alert system as set forth in claim 2, wherein each of the patient device and caregiver device further comprise a microphone and audio output device, whereby a patient and a caregiver can communicate with one another wirelessly through speaking into the microphone and receiving an audible response from the corresponding audio output device.

4. The caregiver alert system as set forth in claim 3, further comprising a plurality of patient devices, each adapted to generate a unique alert signal, and wherein the caregiver device is adapted to recognize which patient device is generating the alert signal.

5. The caregiver alert system as set forth in claim 4, wherein the caregiver device is programmable to associate at least one of a name and room number with a particular alert signal, such that upon receiving an alert signal, the alert indicator indicates which patient device generated the alert signal.

6. The caregiver alert system as set forth in claim 5, wherein the caregiver device further comprises a display for displaying at least one of a name and room number that is associated with the alert signal.

7. The caregiver alert system as set forth in claim 1, wherein each of the patient device and caregiver device further comprise a microphone and audio output device, whereby a patient and a caregiver can communicate with one another wirelessly through speaking into the microphone and receiving an audible response from the corresponding audio output device.

8. The caregiver alert system as set forth in claim 1, further comprising a plurality of patient devices, each adapted to generate a unique alert signal, and wherein the caregiver device is adapted to recognize which patient device is generating the alert signal.

9. The caregiver alert system as set forth in claim 8, wherein the caregiver device is programmable to associate at least one of a name and room number with a particular alert signal, such that upon receiving an alert signal, the alert indicator indicates which patient device generated the alert signal.

10. The caregiver alert system as set forth in claim 9, wherein the caregiver device further comprises a display for displaying at least one of a name and room number that is associated with the alert signal.
